(19) United States
(12) Patent Application Publication
(10) Pub. No.: US 2016/0077552 A1
(43) Pub. Date: Mar. 17, 2016

(54) WEARABLE DEVICE AND CONTROL METHOD THEREOF

(71) Applicant: HON HAI PRECISION INDUSTRY CO., LTD., New Taipei (TW)

(72) Inventor: PO-HSIEN LIU, New Taipei (TW)

(21) Appl. No.: 14/587,185

(22) Filed: Dec. 31, 2014

(30) Foreign Application Priority Data
Sep. 11, 2014 (TW) 103131447

(51) Int. Cl. G06F 1/16; G09G 5/14; G09G 5/00; G06F 3/01; G06F 3/041

(52) U.S. Cl. CPC G06F 1/1652; G06F 1/163; G06F 3/01; G06F 3/0416; G09G 5/003; G09G 5/14; G06F 2200/1637

(57) ABSTRACT

A wearable device includes a flexible display screen for displaying information. The flexible display screen includes different display areas. The wearable device further includes an input setting module and a display control module electrically connected to the input setting module. The input setting module is configured to input a plurality of information about a plurality of display areas and a plurality of information to be displayed of users' needs, and transmit the input information to the display control module. The display control module controls the set display areas to display the set information according to the input setting module.

### FIELD

The subject matter herein generally relates to wearable devices.

### BACKGROUND

Traditional wearable devices usually have only a display area configured to a plurality of information such as time, weather, and short message service in display area. Users cannot apply settings on a plurality of display areas according to individual needs and preference.

### BRIEF DESCRIPTION OF THE DRAWINGS

Implementations of the present technology will now be described, by way of example only, with reference to the attached figures.

FIG. 1 is an isometric view of an embodiment of a wearable device.

FIG. 2 is a diagrammatic view of the wearable device of FIG. 1.

FIG. 3 is a view of the wearable device of FIG. 1 while being used.

FIG. 4 is a flow diagram of an embodiment of a control method of the wearable device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The term “comprising,” when utilized, means “including, but not necessarily limited to”; it specifically indicates open-ended inclusion or membership in the so-described combination, group, series and the like.

The present disclosure is described in relation to a wearable device and a control method thereof.

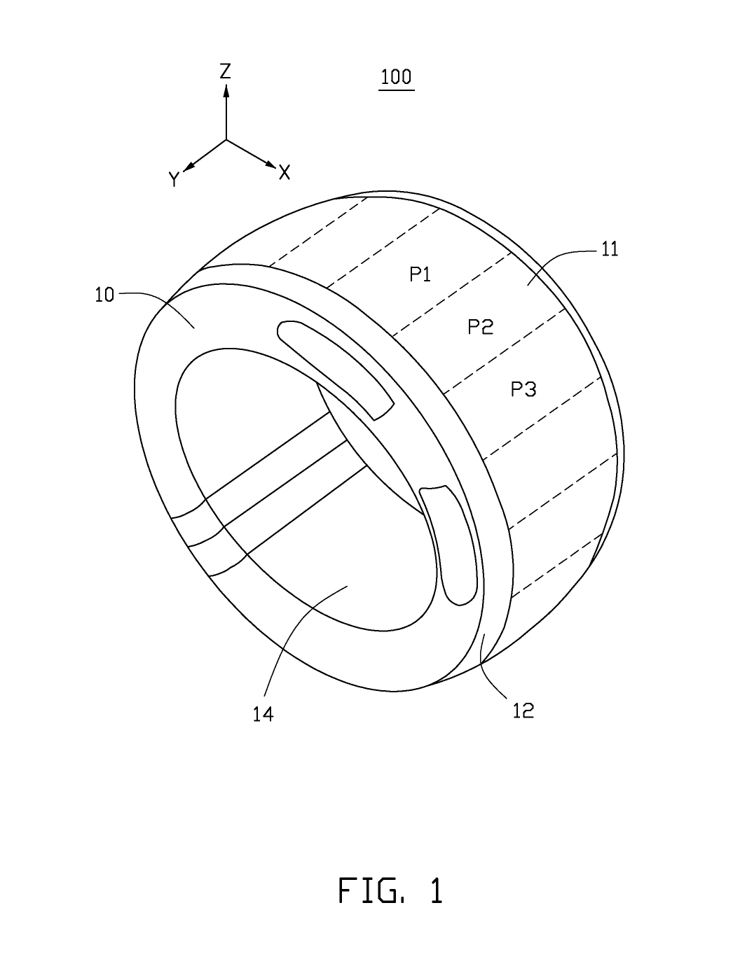

FIG. 1 illustrates an embodiment of a wearable device 100 such as a smart-watch configured to apply to watch phones and watch keys. The wearable device 100 can include a main body 10 and a flexible display screen 11 positioned on the main body 10. The main body 10 can be circled around a wrist of a user (not shown). The main body 11 can include a first surface 12 and a second surface 14 opposite to the first surface 12. The flexible display screen 11 can be positioned on the first surface 12. The flexible display screen 11 and the main body 10 can be circled around a wrist of a user (not shown) and can be unfolded flat. The flexible display screen 11 can be a touch screen. The flexible display screen 11 can further include a plurality of independent display areas (such as P1, P2, P3, and so on) each display area being configured to display a plurality of different information. The different information can be displayed on only one display area or on a plurality of display areas. For example, the display area P1 can be set to display a plurality of time information, and the display area P2 and the display area P3 adjacent to the display area P1 can be respectively set to display a plurality of weather information and a plurality of short message service information. The display area P1 can simultaneously display the time information, the weather information and the short message service information, and the display area P1 and the display area P2 can also individually display the same information.

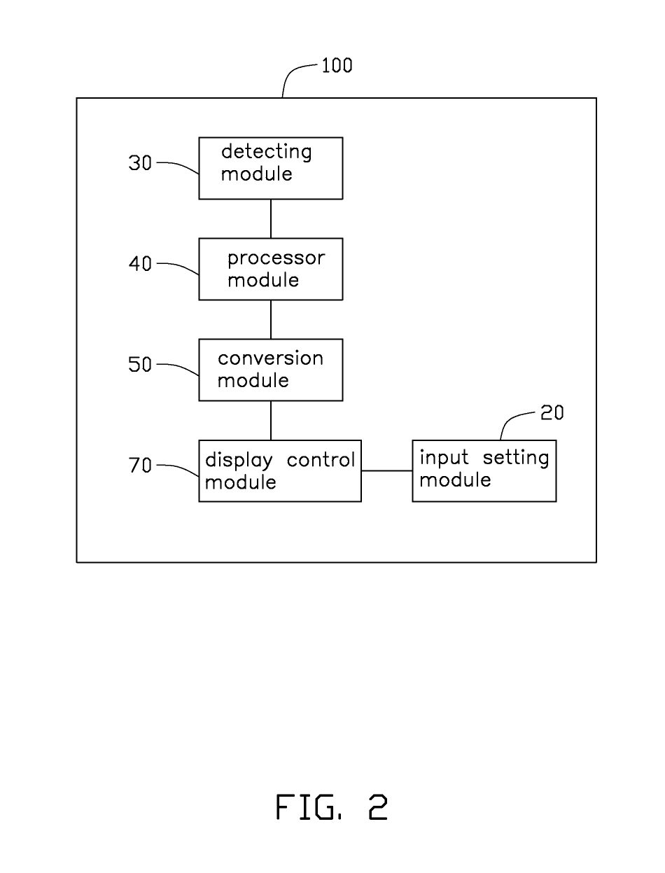

FIG. 2 illustrates that the wearable device 100 can further include an input setting module 20, a detecting module 30, a processor module 40, a conversion module 50 and a display control module 70. The input setting module 20 can be electrically connected to the display control module 70. The processor module 40 can be electrically connected to the detecting module 30 and the conversion module 50.

The input setting module 20 can be configured to input a plurality of information about a plurality of display areas and a plurality of preferred displays, and can transmit the input information to the display control module 70. The display control module 70 can control the set display areas to display the set information according to the transmitted information by the input setting module 20. Users can thus set a plurality of the display areas and a plurality of information to be displayed according to individual needs and preferences via the input setting module 20. For example, to save electricity, the users can set time information on only one display area when users need the time information. The users can set time information, weather information, and short message service information on only one display area or on a plurality of different display areas according to individual needs and preferences.

The detecting module 30 can detect a rotational acceleration of the flexible display screen 11 (shown in FIG. 1) relative to an original viewing orientation. The original viewing orientation can be a display orientation of the users' convenience. In addition, the original viewing orientation can be set according to the needs of users. The detecting module 30 can be a three-axis gravity sensor. The detecting module 30 can detect the rotational acceleration of the flexible display screen 11 along the X, Y, and Z ordinates (shown in FIG. 1) and can transmit the information of the rotational acceleration to the processor module 40. The processor module 40 can measure a rotational angle and a rotational orientation of the flexible display screen 11 according to the rotational acceleration of the flexible display screen 11 (shown in FIG. 1).

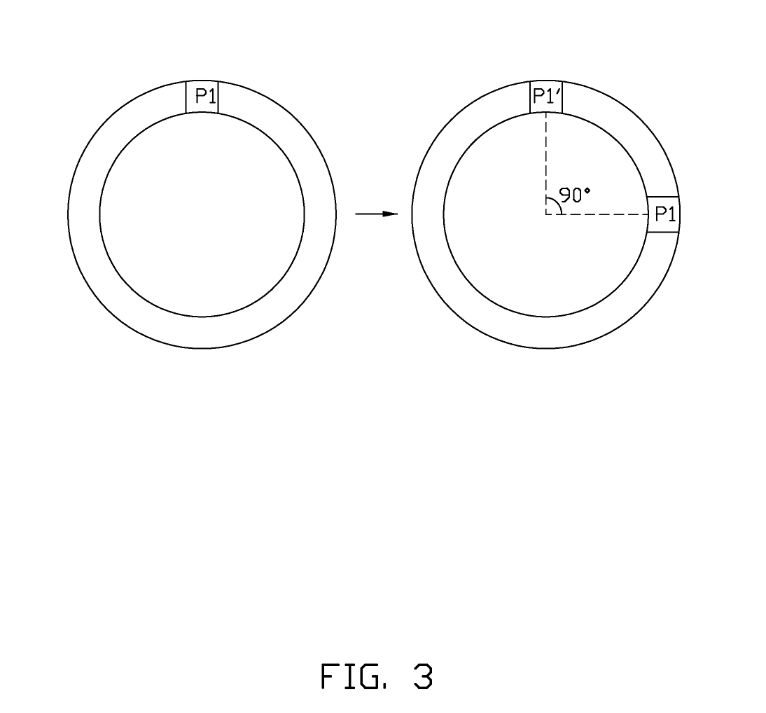

FIGS. 1-3 illustrate that the conversion module 50 can redefine a new display area according to the rotational angle and the rotational orientation of the flexible display screen 11. For example, an original display information can appear on a display area P1 in an original viewing orientation. The processor module 40 can receive the information that the flexible display screen 11 is rotated 90 degrees clockwise relative to the original viewing orientation. The conversion module 50 can determine a new display area P1′ for the original display information according to a rotational angle and a rotational orientation of the flexible display screen 11 relative to the original viewing orientation. The position of the new display area P1′ can overlap the original position of the display area P1 to always present the original display information of the flexible display screen 11 in the original viewing orientation. Therefore, the original display information can always be viewed when the flexible display screen 11 is rotated.

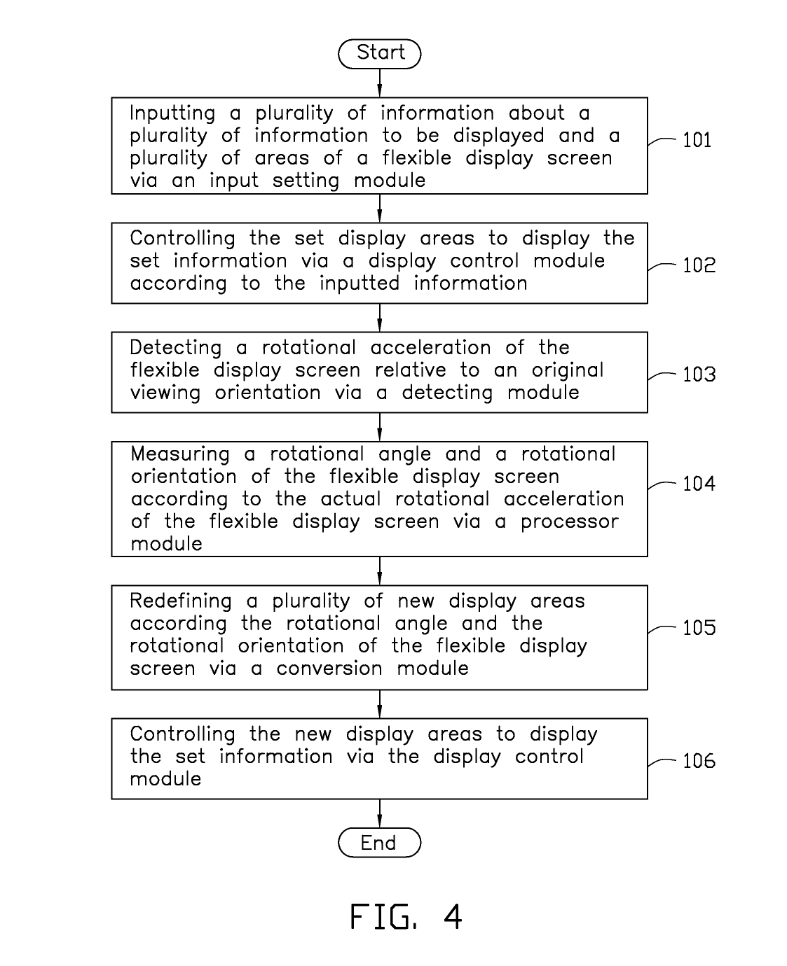

Referring to FIG. 4, a flowchart is presented in accordance with an example embodiment which is being thus illustrated. A control method of the wearable device 100 is provided by way of example, as there are a variety of ways to carry out the method. The control method of the wearable device 100 described below can be carried out using the configurations illustrated in FIGS. 1 and 2, for example, and various elements of these figures are referenced in explaining example control method of the wearable device 100. Each block shown in FIG. 4 represents one or more processes, methods or subroutines, carried out in the example control method of the wearable device 100. Additionally, the illustrated order of blocks is by example only and the order of the blocks can change according to the present disclosure. The control method of the wearable device 100 can begin at block 101.

At block 101, a plurality of display information and a plurality of display areas for users' needs can be inputted via the input setting module 20 and can be transmitted to the display control module 70.

At block 102, the display control module 70 can control the set display areas to display the set information according to the transmitted information by the input setting module 20.

At block 103, a rotational acceleration of the flexible display screen 11 relative to an original viewing orientation can be detected via the detecting module 30.

At block 104, a rotational angle and a rotational orientation of the flexible display screen 11 can be measured via the processor module 40 according to the actual rotational acceleration of the flexible display screen 11.

At block 105, a plurality of new display areas can be redefined via the conversion module 50 according to the rotational angle and the rotational orientation of the flexible display screen 11.

At block 106, the display control module 70 can control the new display areas to display the set information to always locate the display areas of the flexible display screen 11 always be located in the same original viewing orientation.

In the other embodiments, a plurality of display information and a display area for users' needs can be inputted via a button (not shown). Users can also set other display areas and other information after the display control module 70 can control the new display areas to display set display information.

As described above, users can set a plurality of information to be displayed and a plurality of display areas according to individual needs and preference via the input setting module 20. In addition, the conversion module 50 can redefine a new display area according to the angle of rotation and the rotational orientation of the flexible display screen 11, as measured by the detecting module 30 and the processor module 40. Therefore, the display areas of the flexible display screen 11 can always be located in the original viewing orientation for convenience.

The embodiments shown and described above are only examples. Many details are often found in the art such as the other features of a wearable device and a control method thereof. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including matters of shape, size and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A wearable device comprising:
a main body;
a flexible display screen positioned on the main body;
an input setting module; and
a display control module electrically connected to the input setting module;
wherein the flexible display screen comprises a plurality of independent display areas configured to display information;
wherein the input setting module is configured to input a plurality of information to be displayed about a plurality of display areas and a plurality of information of users' needs, and transmits the input information to the display control module; and
wherein the display control module controls the display areas to display the set information according to the input setting module.

2. The wearable device as claimed in claim 1, wherein the wearable device further comprises a detecting module, a processor module, and a conversion module, and the processor module is electrically connected to the detecting module and the conversion module.

3. The wearable device as claimed in claim 2, wherein the detecting module detects the rotational acceleration of the flexible display screen relative to an original viewing orientation.

4. The wearable device as claimed in claim 3, wherein the processor module measures a rotational angle and a rotational orientation of the flexible display screen according to the rotational acceleration of the flexible display screen.

5. The wearable device as claimed in claim 4, wherein the conversion module redefines a plurality of new display areas according to the rotational angle and the rotational orientation of the flexible display screen to always locate the set information of the flexible display screen in the original viewing orientation.

6. The wearable device as claimed in claim 5, wherein the display control module also controls the new display areas to display the set information.

7. The wearable device as claimed in claim 2, wherein the detecting module is a three-axis gravity sensor.

8. The wearable device as claimed in claim 1, wherein the flexible display screen is a touch screen.

9. The wearable device as claimed in claim 1, wherein the main body comprises a first surface and a second surface opposite to the first surface, and the flexible display screen is positioned on the first surface.

10. The wearable device as claimed in claim 1, wherein the flexible display screen and the main body are circled around a wrist of a user and are unfolded flat.

11. A control method of the wearable device comprising:
inputting a plurality of information about of display information and a plurality of display areas of a flexible display screen via an input setting module; and
controlling the set display areas to display the set information via a display control module according to the inputted information transmitted by the input setting module.

12. The control method of the wearable device as claimed in claim 11, wherein the control method of the wearable device further comprises:
detecting a rotational acceleration of the flexible display screen relative to an original viewing orientation via a detecting module;
measuring a rotational angle and a rotational orientation of the flexible display screen according to the actual rotational acceleration of the flexible display screen via a processor module;
redefining a plurality of new display areas according to the rotational angle and the rotational orientation of the flexible display screen via a conversion module; and
controlling the new display areas to display the set information via the display control module.

13. The control method of the wearable device as claimed in claim 12, wherein the control method of the wearable device further comprising:
setting other display areas and other information to be displayed via the input setting module and the display control module after the display control module controls the new display areas to display set information.

14. The control method of the wearable device as claimed in claim 12, wherein the detecting module is a three-axis gravity sensor.
